(19) United States
(12) Patent Application Publication
(10) Pub. No.: US 2026/0057429 A1
(43) Pub. Date: Feb. 26, 2026

(54) SYSTEM AND METHOD FOR SCRAPING PRODUCT PRICES, PROVIDING ALERTS FOR PRICE CHANGES AND INVENTORY STATUS

(71) Applicant: RAM JASHAN PAIDI, Leander, TX (US)

(72) Inventor: RAM JASHAN PAIDI, Leander, TX (US)

(21) Appl. No.: 18/813,410

(22) Filed: Aug. 23, 2024

(51) Int. Cl. G06Q 30/0601; G06F 16/951; G06Q 10/087

(52) U.S. Cl. CPC G06Q 30/0629; G06F 16/951; G06Q 10/087

(57) ABSTRACT

Exemplary embodiments of the present disclosure are directed towards a system for scraping product prices, providing alerts for price changes and inventory status. The system includes a computing device with a user interacting module, allowing users to select products by entering names and preferences. The module transmits product details to a server over a network. The server comprises a data scraping module that receives the details and utilizes Selenium API and website API to collect and compare prices from multiple online sources, identifying the lowest price. The system generates alerts for the lowest price and inventory status, which are sent back to the computing device. The user interacting module allows users to view these alerts, accept or reject deals, and facilitates order placement and payment processing for accepted deals. If a deal is rejected, the system repeats the price comparison process and issues low inventory alerts if necessary.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present invention pertains to the domain of e-commerce and online shopping, specifically focusing on systems and methods for automated real-time price scraping, dynamic deal alerts, and inventory status monitoring. This invention utilizes web scraping technologies and real-time data monitoring to track and analyze price changes and inventory levels across various e-commerce platforms and databases. By leveraging advanced algorithms for parsing diverse website structures and aggregating data into a centralized system, the invention ensures accurate and up-to-date pricing information. The technology enhances the efficiency of price comparison, streamlines the discovery of deals, and provides timely alerts about significant price drops and inventory changes, ultimately helping consumers make informed purchasing decisions while saving time and money.

### BACKGROUND

The rise of e-commerce has significantly transformed the way consumers shop for products, offering unprecedented access to a vast array of goods and services online. However, one of the major challenges consumers face is efficiently tracking and comparing prices across multiple e-commerce platforms to ensure they are getting the best possible deals. Over time, several systems and methods have been developed to aid consumers in this endeavor, but they come with notable disadvantages and drawbacks. Price comparison websites, such as Google Shopping and Shopzilla, were developed to simplify the process of comparing product prices from multiple retailers. These websites aggregate prices and product information from a variety of online stores, presenting users with a consolidated view of available options. However, these platforms have several significant drawbacks. They often rely on partnerships with specific retailers to display their products and prices, which means that not all available retailers are represented, potentially excluding those offering lower prices. Consequently, users might miss out on better deals from non-partner retailers. Additionally, these websites typically update their data at intervals, not in real-time, leading to situations where users encounter discrepancies between the listed price and the actual price on the retailer's site. The absence of customizable alerts also means that users must manually check for price updates and changes, making it easy to miss significant price drops or time-sensitive deals.

Similarly, browser extensions, such as Honey, have become popular tools for price tracking and deal alerts. These extensions integrate with the user's web browser, tracking prices for products as users browse e-commerce websites. Despite their popularity, browser extensions come with notable limitations. They are often limited to tracking prices on a specific set of e-commerce websites, narrowing the scope of price comparison and potentially missing out on lower prices available on untracked websites. Furthermore, many browser extensions focus on tracking prices through selected retailers only, preventing comprehensive price comparison across multiple retailers. This limitation reduces the user's ability to find the absolute lowest price for a product. Additionally, the effectiveness of browser extensions can vary depending on the structure and format of the websites they are tracking. Differences in how prices are displayed can lead to inconsistencies and inaccuracies in price tracking, reducing the reliability of the information provided to users.

The existing systems and methods face several technical challenges that limit their effectiveness in providing accurate and comprehensive price comparison and tracking. Aggregating data from multiple e-commerce websites with varying formats and structures is complex, and ensuring consistency and accuracy in the gathered data is a significant technical hurdle. Providing real-time price updates requires continuous monitoring of numerous websites, which is resource-intensive. Existing solutions often lack the capability to offer real-time data, leading to outdated information being presented to users. Effective price tracking systems need to offer customizable alerts to notify users of significant price changes or deals, but implementing a robust alert system that can handle user preferences and provide timely notifications is a challenging task.

While existing price comparison websites and browser extensions have provided valuable tools for consumers to track and compare prices, they come with significant limitations. The inability to include all available retailers, reliance on outdated information, and lack of customizable alerts are major drawbacks. Additionally, the technical challenges of data aggregation, real-time updates, and effective user alerts further constrain their effectiveness. These limitations highlight the need for more advanced solutions that can offer comprehensive, accurate, and timely price tracking and comparison for consumers.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards a system for scraping product prices, providing alerts for price changes and inventory status.

Another objective of the present disclosure is directed towards automating price tracking by developing a system that is scraping and monitoring prices for selected products from various e-commerce websites and databases, thereby eliminating the need for manual price comparison by consumers.

Another objective of the present disclosure is directed towards ensuring real-time data by providing real-time price updates and notifications through the use of web scraping technologies and regular price checks, ensuring that users are receiving the most current information on product prices.

Another objective of the present disclosure is directed towards enhancing data accuracy by improving the accuracy and reliability of price information through the comparison of data collected using different methods, such as Selenium and regular API pulls, thereby reducing the risk of inaccuracies.

Another objective of the present disclosure is directed towards streamlining deal discovery by creating a system that aggregates pricing data and identifies significant price drops or discounts, making it easier for consumers to find and act on the best deals without extensive manual effort.

Another objective of the present disclosure is directed towards providing customizable alerts by offering a flexible alert mechanism that is notifying users of price changes and inventory status through email or text messages, allowing them to make timely purchasing decisions.

Another objective of the present disclosure is directed towards increasing efficiency by automating the process of tracking and comparing prices across multiple platforms, thereby saving users time and effort compared to manual price checking.

Another objective of the present disclosure is directed towards ensuring accurate and timely information by employing real-time monitoring and cross-verification of data, ensuring that users are receiving accurate and up-to-date pricing information and reducing the chances of missing out on the best deals.

Another objective of the present disclosure is directed towards providing customizable alerts by setting up personalized alerts for significant price drops or low inventory, ensuring that users are promptly informed of opportunities to purchase products at the lowest possible prices.

Another objective of the present disclosure is directed towards offering comprehensive coverage by scraping data from a wide range of e-commerce sites and databases, thereby providing broader coverage compared to tools limited to specific retailers or websites and increasing the chances of finding the best deals.

Another objective of the present disclosure is directed towards improving accuracy through cross-verification by comparing prices obtained from different sources, such as Selenium and regular APIs, thereby enhancing data accuracy and reliability and reducing the likelihood of errors and discrepancies.

Another objective of the present disclosure is directed towards enhancing user experience by integrating real-time price tracking, dynamic alerts, and comprehensive data scraping, contributing to a more efficient and user-friendly experience for finding and acting on the best deals online.

Another objective of the present disclosure is directed towards optimizing B2B procurement systems by providing real-time price data to facilitate cost-effective purchasing decisions, enhancing supply chain operations.

Another objective of the present disclosure is directed towards improving B2C pricing comparison tools by enabling users to receive alerts when a product is available at a lower price across multiple retailers, overcoming the limitations of existing tools that only track prices at individual retailers.

According to an exemplary aspect of the present disclosure, a system for scraping product prices, providing alerts for price changes and inventory status.

According to another exemplary aspect of the present disclosure, the system includes a computing device further including a processor for executing instructions from a real time price monitoring module located within the computing device.

According to another exemplary aspect of the present disclosure, the real time price monitoring module configured to enable a user to select a product by inputting the product name and preferences into a search interface, thereby transmitting the user-selected product details to a server over a network.

According to another exemplary aspect of the present disclosure, the server communicatively coupled to the computing device over the network.

According to another exemplary aspect of the present disclosure, the server includes a data scraping module configured to receive user product selection details from the real time price monitoring module, utilize Selenium API and website API to collect and analyze product price data from multiple online sources, thereby identify the lowest price for the user selected product(s) by comparing the collected data,

According to another exemplary aspect of the present disclosure, the data scraping module configured to generate alerts for the lowest price and inventory status; and transmit alerts to the computing device.

According to another exemplary aspect of the present disclosure, the computing device comprises the real time price monitoring module configured to receive alerts from the server regarding the lowest product price and inventory status.

According to another exemplary aspect of the present disclosure, the real time price monitoring module configured to enable the user to access the alerts and respond by accepting or rejecting the deal.

According to another exemplary aspect of the present disclosure, the real-time price monitoring module is further configured to enable the user to place an order and redirect the user to a payment process when the user accepts the deal, and to repeat the price comparison process if the user rejects the deal.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram depicting a schematic representation of a system for scraping product prices, providing alerts for price changes and inventory status, in accordance with one or more exemplary embodiments.

FIG. 2 is a block diagram depicting an embodiment of the real time price monitoring module 116 on the computing device, in accordance with one or more exemplary embodiments.

FIG. 3 is a block diagram depicting an embodiment of the data scraping module 118 at the server, in accordance with one or more exemplary embodiments.

FIG. 4 is a flow diagram depicting a method for identifying the lowest price of the selected product, in accordance with one or more exemplary embodiments.

FIG. 5 is a flow diagram depicting a method for identifying the discounts on the product price, in accordance with one or more exemplary embodiments.

FIG. 6 is a flow diagram depicting a method for notifying inventory count to the use, in accordance with one or more exemplary embodiments.

FIG. 7 is a flow diagram depicting a method for scraping product prices, providing alerts for price changes, in accordance with one or more exemplary embodiments.

FIG. 8 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

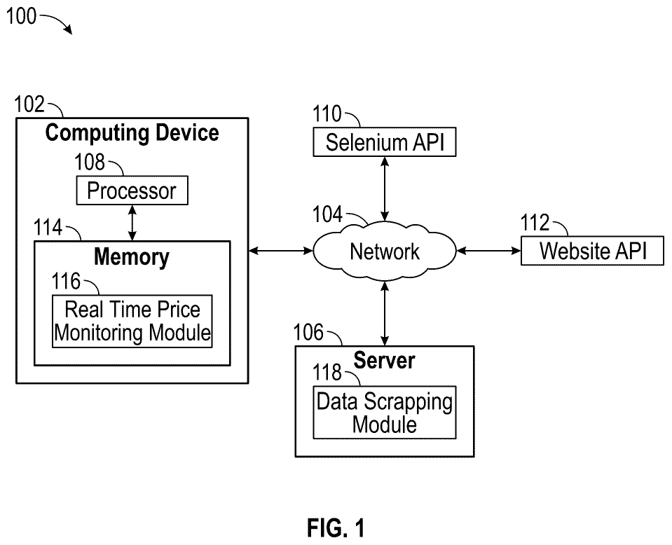

Referring to FIG. 1 is a block diagram 100 depicting a schematic representation of a system for scraping product prices, providing alerts for price changes and inventory status, in accordance with one or more exemplary embodiments. The system 100 includes a computing device 102, a network 104, a server 106, a processor 108, selenium API 110, website API 112, memory 114, a real time price monitoring module 116, and a data scrapping module 118.

The computing device 102 may include user device. The computing device 102 may include, but is not limited to, a personal digital assistant, smartphones, personal computers, a mobile station, computing tablets, a handheld device, an internet enabled calling device, an internet enabled calling software, a telephone, a mobile phone, a digital processing system, and so forth. The computing device 102 may include the processor 108 in communication with a memory 112. The processor 108 may be a central processing unit. The memory 112 is a combination of flash memory and random-access memory. The processor 108 may execute instructions and process data within the system, including handling user interactions, performing computations for product price comparisons and storage operations. The memory 112 may be configured to store program instructions, data, and temporary information needed for system operations. The memory 112 may include software components for product price comparisons and providing dynamic deal alerts to the user.

In accordance to the exemplary embodiment of the present disclosure, the processor 108 may include but not limited to, a microcontroller (for example ARM 7 or ARM 11), a raspberry pi, a microprocessor, a mini CPU, a digital signal processor, a microcomputer, a field programmable gate array, a programmable logic device, a state machine or logic circuitry, arduino board.

The computing device 102 may be communicatively connected to the server 106 via the network 104. The network 104 may include, but not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure.

Although the computing device 102 is shown in FIG. 1, an embodiment of the system 100 may support any number of computing devices. The computing device 102 may be operated by the user. The user may include, but not limited to, an individual, customer, retailer and the like. The computing device 102 supported by the system 100 is realized as a computer-implemented or computer-based device having the hardware or firmware, software, and/or processing logic needed to carry out the computer-implemented methodologies described in more detail herein.

The real time price monitoring module 116 may be configured to enable the user to select the product by typing product name on search bar on the computing device, the real time price monitoring module 116 provide the particular product price list from different e-commerce platforms and view the product price comparison data by scrapping the multiple e-commerce platforms. The e-commerce platforms may include but not limited to Flipkart® and Amazon®, so forth. The e-commerce platforms may be online sources.

The real time price monitoring module 116 may be configured to enable the user to provide the inputs on the product selections and preferences, the real time price monitoring module 116 may be configured to validate the user inputs about the product selections and preferences.

The real time price monitoring module 116 may transmit collected data about product selection and preferences to the server 106. The server 106 may include a data scraping module 118 configured to receive the data on product selection and preferences. The data scraping module 118 may be configured to analyze user requests regarding the user's product selection. Based on the analyzed user requests, the data scraping module 118 may create a database for user-selected products using the Selenium open-source application programming interface. The system 100 scrapes data from various approved online sources (including retailers, trusted e-commerce websites, and wholesalers) using Selenium. The collected data is then stored in the Product X database. The data scraping module 118 may analyze the data to identify the lowest price for product X. Simultaneously, the data scraping module 118 may create another database for product X using website application programming interfaces. Data may be scraped from approved websites using these interfaces. The collected data is then stored in the product X database. Here Product “X” may be user selected product. The data scraping module 118 may compare prices to find the lowest possible price for Product X. Finally, the data scraping module 118 may check the website APIs against the Selenium database and the stored user-specific product database. The results from Selenium API (Application programming Interface) are compared with data retrieved via website APIs and the stored user-specific product database to ensure accuracy. The data scraping module 118 may generate the best deal alerts and transmit them to the user's computing device 102. The real time price monitoring module 116 on the computing device 102 may receive the lowest price information for the product. The real time price monitoring module 116 may enable the user to view the lowest price information and allow the user to accept or reject the deal. Once the user accepts the deal, the real time price monitoring module 116 redirects to the order placing and payment process. If the user rejects the deal, the data scraping module repeats the product price comparison. Product prices are checked every 15 minutes since all companies change prices at different times. To stay on top of price changes, when a product price change is found, that price will be notified to the user's computing device 102. The payment processing are facilitated through secure payment gateways, ensuring encrypted transactions.

The real time price monitoring module 116 may be any suitable applications downloaded from GOOGLE PLAY® (for Google Android devices), Apple Inc.'s APP STORE® (for Apple devices), or any other suitable database. The real time price monitoring module 116 may be desktop application which runs on Windows or Linux or any other operating system and may be downloaded from a webpage or a CD/USB stick etc. In some embodiments, the real time price monitoring module 116 may be software, firmware, or hardware that is integrated into the computing device 102. The computing devices 102 may present a web page to the user by way of a browser, wherein the webpage comprises a hyper-link may direct the user to uniform resource locator (URL).

In accordance with one or more exemplary embodiments of the present disclosure, a system 100 for scraping product prices, providing alerts for price changes and inventory status. The system 100 may include a computing device 102 includes a processor 108 for executing instructions from a real time price monitoring module located within the computing device 102, the real time price monitoring module 116 may be configured to enable the user to select a product by inputting the product name and preferences into a search interface, thereby transmitting the user-selected product details to a server over a network 104. The server 106 communicatively coupled to the to the computing device 102 over the network, 104 The server 106 includes a data scraping module 118 configured to receive user product selection details from the real time price monitoring module 114, utilize Selenium API 110 and website API 112 to collect and analyze product price data from multiple online sources, thereby identify the lowest price for the user selected product by comparing the collected data, the data scraping module 118 configured to generate alerts for the lowest price and inventory status and transmit alerts to the computing device 102. The computing device 102 includes the real time price monitoring module 116 may be configured to receive alerts from the server 106 regarding the lowest product price and inventory status, the real time price monitoring module 116 configured to enable the user to access the alerts and respond by accepting or rejecting the deal, the real-time price monitoring module 116 is further configured to enable the user to place an order and redirect the user to a payment process when the user accepts the deal, and to repeat the price comparison process when the user rejects the deal.

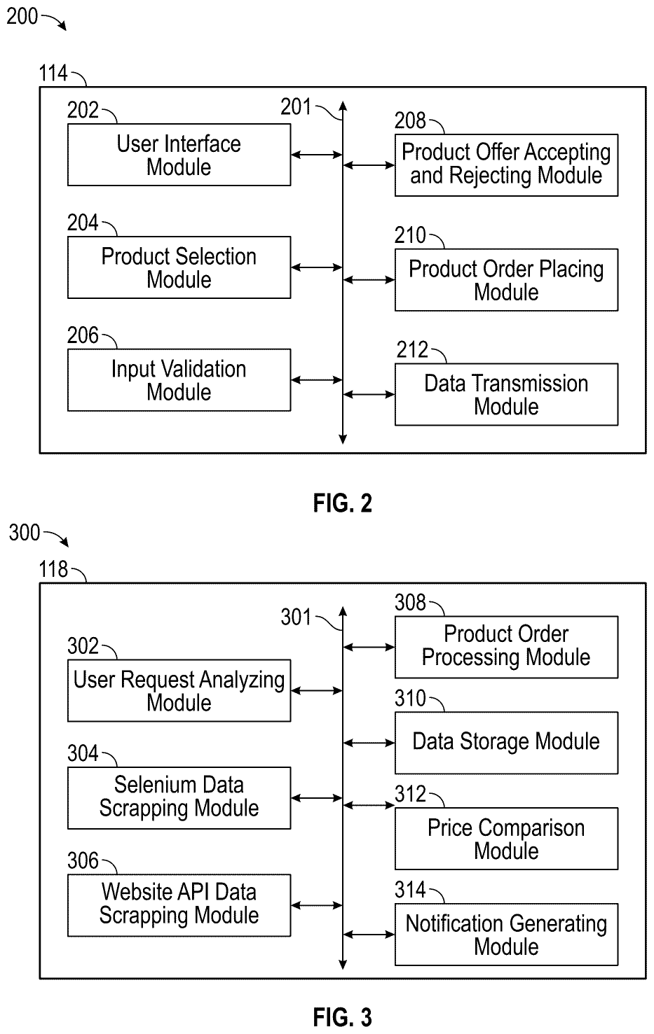

Referring to FIG. 2, a block diagram 200 depicts an embodiment of the real time price monitoring module 116 on the computing device 102, in accordance with one or more exemplary embodiments. The real time price monitoring module 116 includes a bus 201, a user interface module 202, a product selection module 204, an input validation module 206, a product offer accepting and rejecting module 208, a product order placing module 210, and a data transmission module 212. The bus 201 permits communication among the modules of the real time price monitoring module 116 installed on the computing device 102. The term “module” is used broadly herein and refers generally to a program resident in the memory 114 of the computing device 102.

The user interface module 202 may be configured to enable the user to register on the real time price monitoring module 116 installed on the computing device 102 by providing basic details such as email, password, first and last name, phone number, address details, and the like. The user interface module 202 may also be configured to transfer the user registration details to the server 106 over the network 104. The server 106 may include the user data scraping module 118, which receives the user registration details from the user interface module 202. Additionally, the user interface module 202 may enable the user to log in and access the real time price monitoring module 116 using the user login credentials.

The product selection module 202 may be configured to enable the user to select products and view product details on the computing device 102. The input validation module 206 may be configured to validate the user-selected product. After validating the user-selected product, the data transmission module 212 may transmit the data related to the user-selected product to the server 106. The server 106, which includes the data scraping module 118, may receive the data related to the user-selected product and analyze the user request. The data scraping module 118 may compare product prices across various e-commerce platforms to identify the lowest price of the product. It may generate and transmit the best product deal alerts through email and messages, i.e., the lowest price of the product, to the computing device.

The user interface module 202 may enable the user to view the product deal alerts. The product offer accepting and rejecting module 208 may allow the user to accept the product price deal, then redirects to the product order placing module 210. The product order placing module 210 may enable the user to select a payment method to purchase the product. If the user rejects the product price deal, the product price offer accepting and rejecting module 208, along with the data transmission module 212, may transmit the user's rejection of the price deal information to the data scraping module on the server 106 over the network 104.

Referring to FIG. 3, a block diagram 300 depicts an embodiment of the data scraping module 118 at the server, in accordance with one or more exemplary embodiments. The data scraping module 118 may include a bus 301, a user request analyzing module 302, a Selenium data scraping module 304, a website API data scrapping module 306, a product order processing module 308, a data storage module 310, a price comparison module 312, and a notification generating module 314. The bus 301 may include a path that permits communication among the modules of the data scraping module 118 installed on the computing device 102. The term “module”is used broadly herein and refers generally to a program resident in the server 106.

The user request analyzing module 302 may be configured to receive user-selected product details and analyze these details. Based on the analyzed user requests, the Selenium data scraping module 304 may create a database for the user-selected product(s). The Selenium data scraping module 304 is an open-source application programming interface configured to scrape/extract data from various approved online sources (including retailers, trusted e-commerce websites, and wholesalers). The data storage module 310 may collect product price data and store it in the Product X database. The price comparison module 312 may analyze the collected product price data to identify the lowest price for Product X. Simultaneously, the website API data scraping module 306 may create another database for Product X by scraping data from approved websites using these interfaces. The collected data is then stored in the Product X database. Here website may be third party websites such as e-commerce platforms.

The selenium data scraping module 304 and the website API data scraping module 306 transmit the scraped product price data to the price comparison module 312, which receives and checks the website APIs database against the selenium database. The results from selenium are compared with data retrieved via website APIs to ensure accuracy. The notification generating module 314 may generate the best deal alerts and transmit them to the user's computing device 102. The real time price monitoring module 116 on the computing device 102 (As shown in FIG. 1) may receive the lowest price information for the product and enable the user to view this information, allowing them to accept or reject the deal. Once the user accepts the deal, the real time price monitoring module 116 redirects to the order placing and payment process. When the user accepts the deal and proceeds with placing the order, the product order processing module 308 at the server side 106 completes the payment process. If the user rejects the deal, the data scraping module 118 repeats the product price comparison. Product prices are checked every 15 minutes since all companies change prices at different times. To stay on top of price changes, when a product price change is found, it will be notified to the user's computing device 102.

When the lowest product price starts getting low on inventory and was rejected by the user, the notification generating module 314 may generate alerts for the user, allowing them to choose to purchase the product one more time if they don't want to miss out on the best possible price currently.

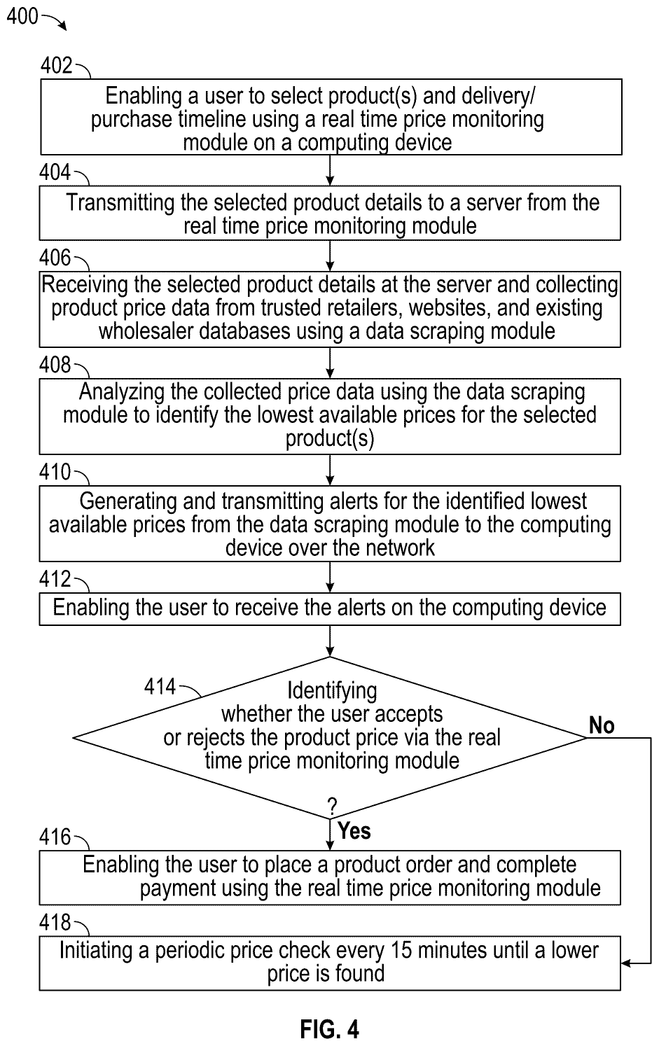

Referring to FIG. 4 is a flow diagram 400 depicting an exemplary method for identifying the lowest price of the selected product, in accordance with one or more exemplary embodiments. The method 400 may be carried out in the context of the details of FIG. 1, FIG. 2, and FIG. 3. However, the method 400 may also be carried out in any desired environment. Further, the aforementioned definitions may equally apply to the description below.

The method commences at step 402, enabling a user to select product(s) and delivery/purchase timeline using a real time price monitoring module on a computing device. Thereafter at step 404, transmitting the selected product details to a server from the real time price monitoring module. Thereafter at step 406, receiving the selected product details at the server and collecting product price data from trusted retailers, websites, and existing wholesaler databases using a data scraping module. Thereafter at step 408, analyzing the collected price data using the data scraping module to identify the lowest available prices for the selected product(s). Thereafter at step 410, generating and transmitting alerts for the identified lowest available prices from the data scraping module to the computing device over the network. Thereafter at step 412, enabling the user to receive the alerts on the computing device. Thereafter at step 414, identifying whether the user accepts or rejects the product price via the real time price monitoring module. If the answer to step 414 is YES, the method continuous at step 416, enabling the user to place a product order and complete payment using the real time price monitoring module. If the answer to step 414 is NO, the method redirects to step 418 and initiating a periodic price check every 15 minutes until a lower price is found.

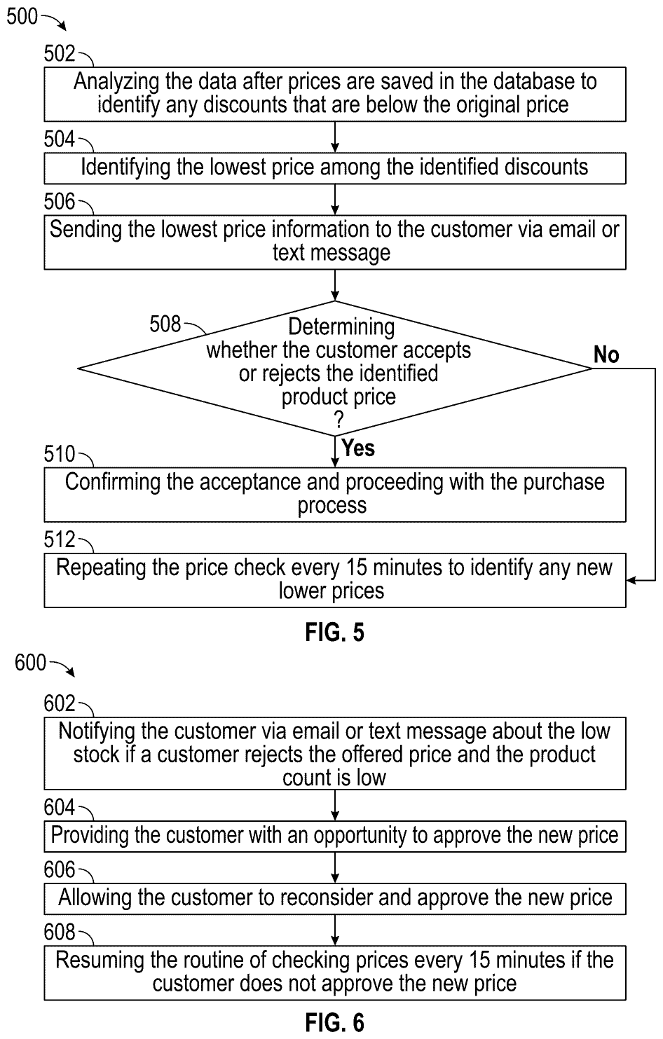

Referring to FIG. 5 is a flow diagram 500 depicting an exemplary method for identifying the discounts on the product price, in accordance with one or more exemplary embodiments. The method 500 may be carried out in the context of the details of FIG. 1, FIG. 2, FIG. 3 and FIG. 4. However, the method 500 may also be carried out in any desired environment. Further, the aforementioned definitions may equally apply to the description below.

The method commences at step 502, analyzing the data after prices are saved in the database to identify any discounts that are below the original price. Thereafter at step 504, identifying the lowest price among the identified discounts. Thereafter at step 506, sending the lowest price information to the customer via email or text message. Thereafter at step 508, determining whether the customer accepts or rejects the identified product price. If the answer to step 508 is YES, the method continuous at step 510, confirming the acceptance and proceeding with the purchase process. If the answer to step 508 is NO, the method continuous at step 512, repeating the price check every 15 minutes to identify any new lower prices.

Referring to FIG. 6 is a flow diagram 600 depicting an exemplary method for notifying inventory count to the user, in accordance with one or more exemplary embodiments. The method 600 may be carried out in the context of the details of FIG. 1, FIG. 2, FIG. 3, FIG. 4 and FIG. 5. However, the method 600 may also be carried out in any desired environment. Further, the aforementioned definitions may equally apply to the description below.

The method commences at step 602, notifying the customer via email or text message about the low stock if a customer rejects the offered price and the product count is low. Thereafter at step 604, providing the customer with an opportunity to approve the new price. Thereafter at step 606, allowing the customer to reconsider and approve the new price. Thereafter at step 608, resuming the routine of checking prices every 15 minutes if the customer does not approve the new price.

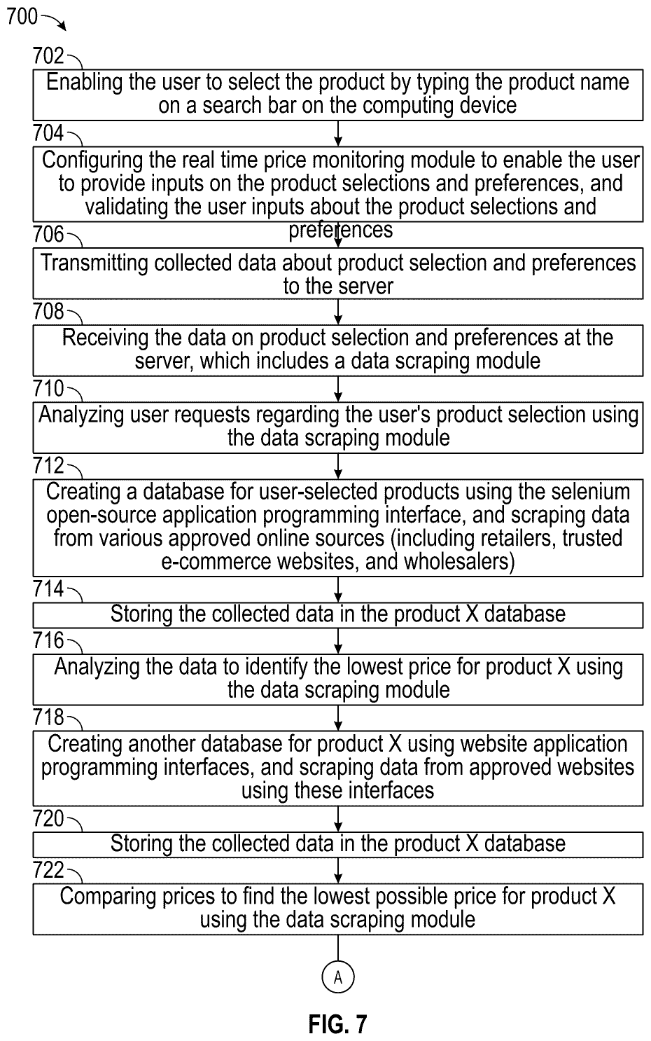

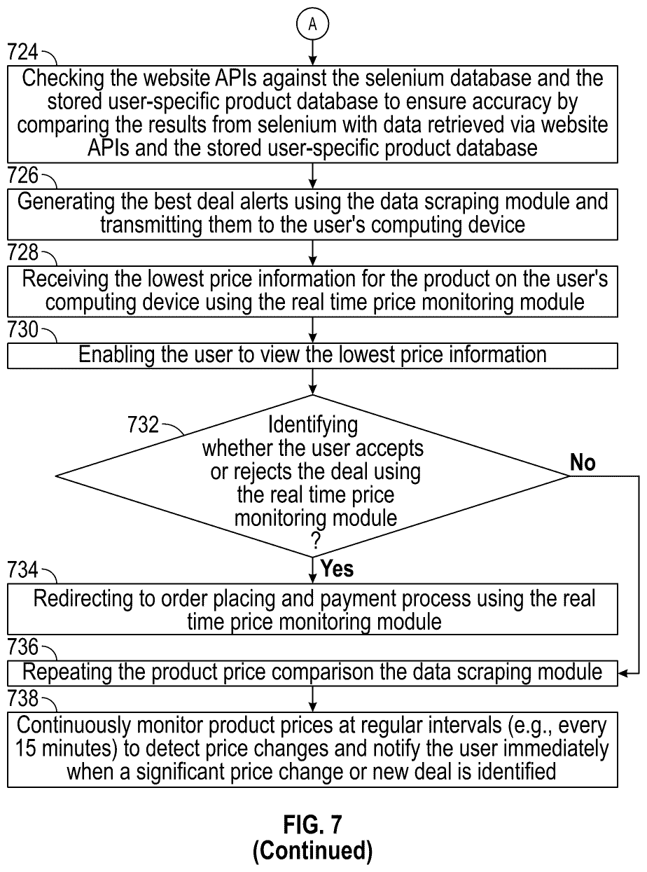

Referring to FIG. 7 is a flow diagram 700 depicting an exemplary method for scraping product prices, providing alerts for price changes, in accordance with one or more exemplary embodiments. The method 700 may be carried out in the context of the details of FIG. 1, FIG. 2, FIG. 3, FIG. 4, FIG. 5 and FIG. 6. However, the method 700 may also be carried out in any desired environment. Further, the aforementioned definitions may equally apply to the description below.

The method commences at step 702, enabling the user to select the product by typing the product name on a search bar on the computing device. Thereafter at step 704, configuring the real time price monitoring module to enable the user to provide inputs on the product selections and preferences, and validating the user inputs about the product selections and preferences. Thereafter at step 706, transmitting collected data about product selection and preferences to the server. Thereafter at step 708, receiving the data on product selection and preferences at the server, which includes a data scraping module. Thereafter at step 710, analyzing user requests regarding the user's product selection using the data scraping module. Thereafter at step 712, creating a database for user-selected products using the Selenium open-source application programming interface, and scraping data from various approved online sources (including retailers, trusted e-commerce websites, and wholesalers). Thereafter at step 714, storing the collected data in the Product X database. Thereafter at step 716, analyzing the data to identify the lowest price for Product X using the data scraping module. Thereafter at step 718, creating another database for Product X using website application programming interfaces, and scraping data from approved websites using these interfaces. Thereafter at step 720, storing the collected data in the Product X database. Thereafter at step 722, comparing prices to find the lowest possible price for Product X using the data scraping module. Thereafter at step 724, Checking the website APIs against the Selenium database and the stored user-specific product database to ensure accuracy by comparing the results from Selenium with data retrieved via website APIs and the stored user-specific product database. Thereafter at step 726, generating the best deal alerts using the data scraping module and transmitting them to the user's computing device. Thereafter at step 728, receiving the lowest price information for the product on the user's computing device using the real time price monitoring module. Thereafter at step 730, enabling the user to view the lowest price information. Thereafter at step 732, identifying whether the user accepts or rejects the deal using the real time price monitoring module. If the answer to step 732 is YES, the method continuous to step 734, redirecting to order placing and payment process using the real time price monitoring module. If the answer to step 732 is NO, the method continuous to step 736, repeating the product price comparison the data scraping module. Thereafter at step 738, continuously monitor product prices at regular intervals (e.g., every 15 minutes) to detect price changes and notify the user immediately when a significant price change or new deal is identified.

In accordance with one or more exemplary embodiments of the present disclosure, a method for scraping product prices, providing alerts for price changes, and notifying inventory status includes enabling a user to select a product by inputting the product name and preferences into a search interface on a computing device using a real time price monitoring module, transmitting user-selected product details to a server over a network. Receiving the user product selection details at the server and collecting product price data from multiple online sources using a data scraping module configured with Selenium API and website API, analyzing the collected price data using the data scraping module to identify the lowest available price for the selected product by comparing the collected data, generating alerts for the lowest price and inventory status using the data scraping module and transmitting the alerts to the computing device, receiving the alerts on the computing device using the real time price monitoring module and enabling the user to view these alerts and respond by accepting or rejecting the deal, facilitating order placement and payment processing using the real time price monitoring module if the deal is accepted and repeating the price comparison process using the data scraping module and handling low inventory alerts if the deal is rejected, including notifying the user about low stock via email or text message, allowing the user to reconsider and approve the new price, and resuming the routine of checking prices at regular intervals if the customer does not approve the new price.

In accordance with one or more exemplary embodiments of the present disclosure, a method for scraping product prices, providing alerts for price changes, and inventory status includes enabling a user to select a product by inputting the product name and preferences into a search interface on a computing device, transmitting the user-selected product details from the computing device to a server over a network, receiving the user-selected product details at the server from the computing device, utilizing selenium API and website API by a data scraping module on the server to collect and analyze product price data from multiple online sources, identifying the lowest price for the user-selected product(s) by comparing the collected data on the server, generating alerts for the lowest price and inventory status by the data scraping module on the server, transmitting the alerts from the server to the computing device, receiving the alerts on the computing device regarding the lowest product price and inventory status, enabling the user to access the alerts on the computing device and respond by accepting or rejecting the deal, redirecting the user to a payment process when the user accepts the deal; and repeating the price comparison process if the user rejects the deal.

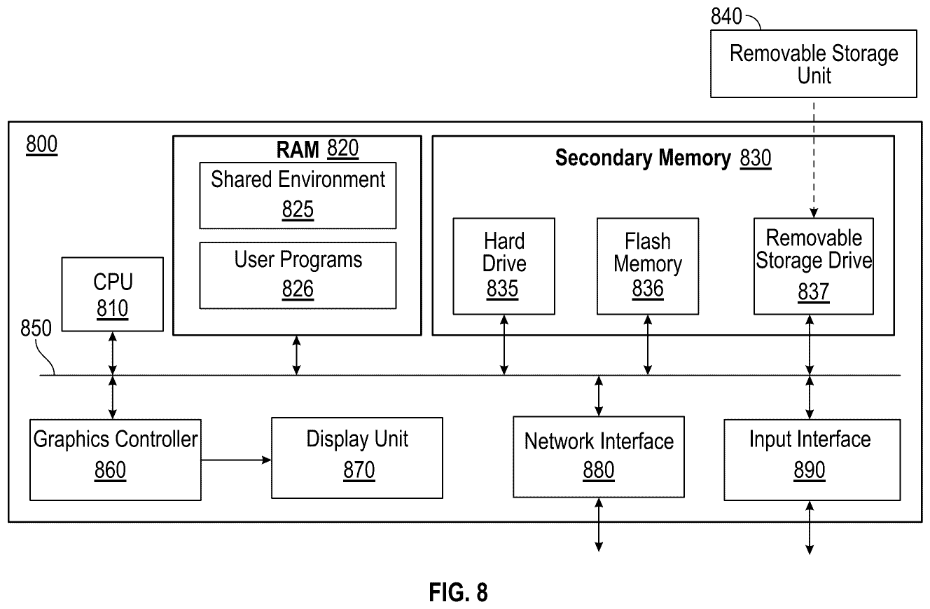

Referring to FIG. 8 is a block diagram 800 illustrating the details of a digital processing system 800 in which various aspects of the present disclosure are operative by execution of appropriate software instructions. The Digital processing system 800 may correspond to the computing device 102 (or any other system in which the various features disclosed above can be implemented).

Digital processing system 800 may contain one or more processors such as a central processing unit (CPU) 810, random access memory (RAM) 820, secondary memory 830, graphics controller 860, display unit 870, network interface 880, and input interface 890. All the components except display unit 870 may communicate with each other over communication path 850, which may contain several buses as is well known in the relevant arts. The components of FIG. 8 are described below in further detail.

CPU 810 may execute instructions stored in RAM 820 to provide several features of the present disclosure. CPU 810 may contain multiple processing units, with each processing unit potentially being designed for a specific task. Alternatively, CPU 810 may contain only a single general-purpose processing unit.

RAM 820 may receive instructions from secondary memory 830 using communication path 850. RAM 820 is shown currently containing software instructions, such as those used in threads and stacks, constituting shared environment 825 and/or user programs 826. Shared environment 825 includes operating systems, device drivers, virtual machines, etc., which provide a (common) run time environment for execution of user programs 826.

Graphics controller 860 generates display signals (e.g., in RGB format) to display unit 870 based on data/instructions received from CPU 810. Display unit 870 contains a display screen to display the images defined by the display signals. Input interface 890 may correspond to a keyboard and a pointing device (e.g., touch-pad, mouse) and may be used to provide inputs. Network interface 880 provides connectivity to a network (e.g., using Internet Protocol), and may be used to communicate with other systems (such as those shown in FIG. 1) connected to the network 104.

Secondary memory 830 may contain hard drive 835, flash memory 836, and removable storage drive 837. Secondary memory 830 may store the data software instructions (e.g., for performing the actions noted above with respect to the Figures), which enable digital processing system 800 to provide several features in accordance with the present disclosure.

Some or all of the data and instructions may be provided on removable storage unit 840, and the data and instructions may be read and provided by removable storage drive 837 to CPU 810. Floppy drive, magnetic tape drive, CD-ROM drive, DVD Drive, Flash memory, removable memory chip (PCMCIA Card, EEPROM) are examples of such removable storage drive 837.

Removable storage unit 840 may be implemented using medium and storage format compatible with removable storage drive 837 such that removable storage drive 837 can read the data and instructions. Thus, removable storage unit 840 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 840 or hard disk installed in hard drive 835. These computer program products are means for providing software to digital processing system 800. CPU 810 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 830. Volatile media includes dynamic memory, such as RAM 820. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 850. Transmission media can also take the form of acoustic or light waves, such as those generated during radio-wave and infra-red data communications.

According to an exemplary aspect of the present disclosure, the processor executes instructions from the real time price monitoring module, the real time price monitoring module is configured to manage the display of product price comparison results in a user-friendly interface.

According to an exemplary aspect of the present disclosure, the processor executes instructions from the real time price monitoring module, the real time price monitoring module comprises a user interface module is configured to enable the user to register on the real time price monitoring module by providing basic details such as email, password, first and last name, phone number.

According to an exemplary aspect of the present disclosure, the processor executes instructions from the real time price monitoring module, the real time price monitoring module comprises a product selection module is configured to enable the user to select products and view product details on the computing device.

According to an exemplary aspect of the present disclosure, the processor executes instructions from the real time price monitoring module, the real time price monitoring module comprises an input validation module configured to validate user inputs regarding product selections and preferences.

According to an exemplary aspect of the present disclosure, the server executes instructions from the data scraping module, the data scraping module comprises a user request analyzing module is configured to receive user-selected product details from the real time price monitoring module, and analyse user-selected product details.

According to an exemplary aspect of the present disclosure, the server executes instructions from the data scraping module, the data scraping module comprises a selenium data scrapping module is configured to create a database for the user selected product(s), the selenium data scraping module is configured to extract data from various approved online sources.

According to an exemplary aspect of the present disclosure, the server executes instructions from the data scraping module, the data scraping module comprises a price comparison module is configured to analyze the collected/extracted price data from selenium data scraping module the to identify the lowest price for user selected product.

According to an exemplary aspect of the present disclosure, the server executes instructions from the data scraping module, the data scraping module comprises a website API data scraping module is configured to create database by scraping data from approved online sources.

According to an exemplary aspect of the present disclosure, the server executes instructions from the data scraping module, the data scraping module comprises the price comparison module is configured to analyze the collected/extracted price data from the website API data scraping module to identify the lowest price for user selected product.

According to an exemplary aspect of the present disclosure, the server executes instructions from the data scraping module, the data scraping module comprises a data storage module is configured to store extracted product price data from the selenium data scrapping module and the website API data scraping module, further data storage module is configured to organize product price data in database.

According to an exemplary aspect of the present disclosure, the server executes instructions from the data scraping module, the data scraping module comprises the price comparison module is configured to receive the scraped product price data from the selenium data scraping module and the website API data scraping module, and checks the website APIs product price data against the selenium product price data to ensure accuracy in the identified lowest price.

According to an exemplary aspect of the present disclosure, the server executes instructions from the data scraping module, the data scraping module comprises a notification generating module configured to create alerts for the lowest price and inventory status.

According to an exemplary aspect of the present disclosure, the notification generating module is configured to transmit the best deal alerts to the user's computing device for user response.

According to an exemplary aspect of the present disclosure, the processor executes instructions from the real time price monitoring module, the real time price monitoring module comprises a product offer accepting and rejecting module is configured to allow the user to accept/reject the product price deal received from the server.

According to an exemplary aspect of the present disclosure, the server executes instructions from the data scraping module, the data scraping module comprises a product order processing module is configured to process the order placement and payment process when the user accepts the deal.

According to an exemplary aspect of the present disclosure, the order placement and payment processing are facilitated through secure payment gateways, ensuring encrypted transactions.

According to an exemplary aspect of the present disclosure, the processor executes instructions from the real time price monitoring module, the real time price monitoring module is configured to notify the user via email or text message about the low stock when a user rejects the offered price and the product count is low.

According to an exemplary aspect of the present disclosure, the server executes instructions from the data scraping module, the data scraping module is configured to perform periodic price checks at regular intervals to detect and notify price changes.

According to an exemplary aspect of the present disclosure, the regular intervals for price checks are every 15 minutes.

According to an exemplary aspect of the present disclosure, the processor executes instructions from the real time price monitoring module, the real time price monitoring module is configured to log user responses and preferences for future price comparisons and alert customizations.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A system for scraping product prices, providing alerts for price changes and inventory status, comprising:
a computing device comprises a processor for executing instructions from a real time price monitoring module located within the computing device, wherein the real time price monitoring module configured to enable a user to select a product by inputting the product name and preferences into a search interface, thereby transmitting the user-selected product details to a server over a network;
the server communicatively coupled to the to the computing device over the network, whereby the server comprises a data scraping module configured to receive user product selection details from the real time price monitoring module, utilize Selenium API and website API to collect and analyze product price data from multiple online sources, thereby identify the lowest price for the user selected product(s) by comparing the collected data, the data scraping module configured to generate alerts for the lowest price and inventory status; and transmit alerts to the computing device; and
the computing device comprises the real time price monitoring module configured to receive alerts from the server regarding the lowest product price and inventory status, the real time price monitoring module configured to enable the user to access the alerts and respond by accepting or rejecting the deal, wherein the real-time price monitoring module is further configured to enable the user to place an order and redirect the user to a payment process when the user accepts the deal, and to repeat the price comparison process when the user rejects the deal.

2. The system of claim 1, wherein the processor executes instructions from the real time price monitoring module, the real time price monitoring module is configured to manage the display of product price comparison results in a user-friendly interface.

3. The system of claim 1, wherein the processor executes instructions from the real time price monitoring module, the real time price monitoring module comprises a user interface module is configured to enable the user to register on the real time price monitoring module by providing basic details such as email, password, first and last name, phone number.

4. The system of claim 1, wherein the processor executes instructions from the real time price monitoring module, the real time price monitoring module comprises a product selection module is configured to enable the user to select products and view product details on the computing device.

5. The system of claim 1, wherein the processor executes instructions from the real time price monitoring module, the real time price monitoring module comprises an input validation module configured to validate user inputs regarding product selections and preferences.

6. The system of claim 1, wherein the server executes instructions from the data scraping module, the data scraping module comprises a user request analyzing module is configured to receive user-selected product details from the real time price monitoring module, and analyse user-selected product details.

7. The system of claim 1, wherein the server executes instructions from the data scraping module, the data scraping module comprises a selenium data scrapping module is configured to create a database for the user selected product(s), the selenium data scraping module is configured to extract data from various approved online sources.

8. The system of claim 1, wherein the server executes instructions from the data scraping module, the data scraping module comprises a price comparison module is configured to analyze the collected/extracted price data from selenium data scraping module to identify the lowest price for user selected product.

9. The system of claim 1, wherein the server executes instructions from the data scraping module, the data scraping module comprises a website API data scraping module is configured to create database by scraping data from approved online sources.

10. The system of claim 1, wherein the server executes instructions from the data scraping module, the data scraping module comprises the price comparison module is configured to analyze the collected/extracted price data from the website API data scraping module to identify the lowest price for user selected product.

11. The system of claim 1, wherein the server executes instructions from the data scraping module, the data scraping module comprises a data storage module is configured to store extracted product price data from the selenium data scrapping module and the website API data scraping module, further data storage module is configured to organize product price data in database.

12. The system of claim 1, wherein the server executes instructions from the data scraping module, the data scraping module comprises the price comparison module is configured to receive the scraped product price data from the selenium data scraping module and the website API data scraping module, and checks the website APIs product price data against the selenium product price data to ensure accuracy in the identified lowest price.

13. The system of claim 1, wherein the server executes instructions from the data scraping module, the data scraping module comprises a notification generating module configured to create alerts for the lowest price and inventory status.

14. The system of claim 13, wherein the notification generating module is configured to transmit the best deal alerts to the user's computing device for user response.

15. The system of claim 1, wherein the processor executes instructions from the real time price monitoring module, the real time price monitoring module comprises a product offer accepting and rejecting module is configured to allow the user to accept/reject the product price deal received from the server.

16. The system of claim 1, wherein the server executes instructions from the data scraping module, the data scraping module comprises a product order processing module is configured to process the order placement and payment process when the user accepts the deal.

17. The system of claim 16, wherein the order placement and payment processing are facilitated through secure payment gateways, ensuring encrypted transactions.

18. The system of claim 1, wherein the processor executes instructions from the real time price monitoring module, the real time price monitoring module is configured to notify the user via email or text message about the low stock when a user rejects the offered price and the product count is low.

19. The system of claim 1, wherein the server executes instructions from the data scraping module, the data scraping module is configured to perform periodic price checks at regular intervals to detect and notify price changes.

20. The system of claim 19, wherein the regular intervals for price checks are every 15 minutes.

21. The system of claim 1, wherein the processor executes instructions from the real time price monitoring module, the real time price monitoring module is configured to log user responses and preferences for future price comparisons and alert customizations.

22. A method for scraping product prices, providing alerts for price changes, and inventory status, comprising:
enabling a user to select a product by inputting the product name and preferences into a search interface on a computing device;
transmitting the user-selected product details from the computing device to a server over a network;
receiving the user-selected product details at the server from the computing device;
utilizing selenium API and website API by a data scraping module on the server to collect and analyze product price data from multiple online sources;
identifying the lowest price for the user-selected product(s) by comparing the collected data on the server;
generating alerts for the lowest price and inventory status by the data scraping module on the server;
transmitting the alerts from the server to the computing device;
receiving the alerts on the computing device regarding the lowest product price and inventory status;
enabling the user to access the alerts on the computing device and respond by accepting or rejecting the deal;
redirecting the user to a payment process when the user accepts the deal; and
repeating the price comparison process if the user rejects the deal.

23. A computer program product comprising a non-transitory computer-readable medium having a computer-readable program code embodied therein to be executed by one or more processors, said program code including instructions to:
enable a user to select a product by inputting the product name and preferences into a search interface on a computing device;
transmit the user-selected product details from the computing device to a server over a network;
receive the user-selected product details at the server from the computing device;
utilize selenium API and website API by a data scraping module on the server to collect and analyze product price data from multiple online sources;
identify the lowest price for the user-selected product(s) by comparing the collected data on the server;
generate alerts for the lowest price and inventory status by the data scraping module on the server;
transmit the alerts from the server to the computing device;
receive the alerts on the computing device regarding the lowest product price and inventory status;
enable the user to access the alerts on the computing device and respond by accepting or rejecting the deal;
redirect the user to a payment process when the user accepts the deal; and
repeat the price comparison process if the user rejects the deal.
